(19) United States
(12) Patent Application Publication
(10) Pub. No.: US 2008/0164339 A1
(43) Pub. Date: Jul. 10, 2008

(54) Device For Atomising A Product, Particularly A Perfume

(76) Inventor: Nicolas Duru, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/793,393

(22) PCT Filed: Oct. 24, 2005
(86) PCT No.: PCT/EP2005/012345

§ 371 Date: Nov. 8, 2007

Related U.S. Application Data
(60) Provisional application No. 60/639,859, filed on Dec. 29, 2004.

(30) Foreign Application Priority Data
Dec. 20, 2004 (FR) 04/53072

(51) Int. Cl. B05B 17/06

(52) U.S. Cl. 239/102.2; 239/102.1; 239/145

(57) ABSTRACT

The invention discloses a device (1) for atomising a product including:
a reservoir (10) containing the product,
means of atomising the product which include:
   a wall (20) permeable to the product through which the product is sprayed,
   an actuator (40) designed to cause the permeable wall (20) to vibrate thereby atomising the product,
      the device being characterised in that the reservoir contains a porous member (30), in contact with the permeable wall so as to feed product thereto, the porous member occupying substantially the entire volume of the reservoir.

The invention relates to a device for atomising a fluid product and in particular a liquid product. More particularly, the invention discloses a miniature atomising device designed to spray a cosmetic product, particularly a perfume.

The expression “cosmetic product” is understood to mean a product such as defined in Council Directive 93/35/CEE dated 14 Jun. 1993, amending Directive 76/768/CEE for the sixth time.

To atomise perfumes, it is known to use devices wherein the product is atomised under the pressure generated by a propellant gas, such as aerosol type devices, or by a pump. To obtain a good quality spray, such devices require the use of a relatively sophisticated nozzle, in particular a swirl nozzle. All of these devices are relatively cumbersome and are designed to remain in a bathroom or to be carried in a toilet bag.

Piezoelectric systems can also be used to eject a perfume. It is already known from documents WO03/066115, WO00/53337 and U.S. Pat. No. 5,518,179 to use vibrating plates to disperse a product in the form of a cloud of fine droplets. The devices described in these documents include a reservoir of liquid product and an ejection system incorporating a membrane having one or more apertures for passage of the product. A piezoelectric member is provided which, when it is deformed under the effect of an electrical field, causes the membrane to vibrate thereby causing the product to emerge in the form of fine droplets through the apertures. In these devices, the product is delivered to the apertures in the membrane by means of a wick which is immersed in the product reservoir.

Apart from the fact that these devices are relatively cumbersome and are designed to remain in a bathroom or to be displayed in a store, problems of leakage can occur. The devices must in particular be used vertically to avoid spilling the liquid from the reservoir. Moreover, it is relatively difficult sufficient quantity of product is brought into contact with the membrane without this quantity being too large. In effect, too much or too little pressure of the wick on the membrane prevents correct nebulisation.

Patent application WO95/15822 also describes an atomising device equipped with a piezoelectric system. A capillary open-cell foam is contained in part of the reservoir to contain the liquid to be atomised thereby limiting leakage of the product if the reservoir is damaged. Here again, such a device is relatively cumbersome.

One of the objects of the invention is therefore to propose an atomising device which does not present the drawbacks of the prior art.

A particular object of the invention is to provide an atomising device for a product that is of small dimensions, that can be used in all positions, and that can be easily actuated.

It is a further object of the invention to provide an atomising device for a product wherein the quantity of atomised product and the size of the atomised droplets can be controlled.

Another object of the invention is also to provide an atomising device that is relatively simple to make and which presents limited risk of leakage.

According to the invention, these objects can be achieved by providing a device for atomising a product including:
a reservoir containing the product,
means of atomising the product which include:
   a wall permeable to the product through which the product is sprayed,
   an actuator designed to cause the permeable wall to vibrate thereby atomising the product, the reservoir containing a porous member, in contact with the permeable wall so as to feed product thereto, the porous member occupying substantially the entire volume of the reservoir.

The porous member occupying substantially the entire volume of the reservoir means that it occupies more than 90% of the reservoir, so that substantially the whole of the fluid product contained in the reservoir is held in the porous member. The ability of the product to move freely inside the reservoir is thus prevented to the maximum degree, thereby limiting the risk of leakage. Furthermore, the quantity of product contained in the reservoir relative to the size of the device is optimised so as to obtain a relatively compact device which can be portable.

The actuator can include a piezoelectric element. As a variant, the actuator can include a magnetostrictive element that is capable of vibrating when it is subjected to a magnetic field.

The porous member can be compressible. In particular, the porous member can be at least partially compressed inside the reservoir. The porous member can include fibres of polyurethane, polyamide, PET, or polyethylene. Alternatively, the porous member can be a foam in a material selected from polyurethane or polyamide.

The permeable wall can be a membrane perforated by one or more apertures. As a variant, the permeable wall can be a mesh.

The permeable wall can be fixed on the actuator. In particular, the actuator can be in the form of an annular disc having a central opening, the product-permeable wall being disposed in the central opening of the disc.

The reservoir can include a sidewall and a bottom, the actuator being fixed on the edge of the sidewall, opposite the bottom.

The piezoelectric element can include a plate in a material selected from ceramics, in particular zirconate (PZT), metaniobate (PN), barium titanate, or zinc oxide.

The product-permeable wall can be covered by a closure element enabling the reservoir to be closed in a leaktight manner relative to the product, in particular by a cover strip that can be glued around the permeable wall, with the ability to reseal the cover strip after it has been peeled off.

The device can include fixing means enabling it to be mounted in a unit incorporating power supply means.

The device can include an electronic memory wherein product-related information is stored, for example the product type, the quantity remaining, the product expiry date, or an anti-counterfeit code.

The reservoir can delineate a volume between 0.5 and 4 cm³.

Before first use, the device can include between 1 and 5 ml of product to be atomised, preferably between 1 and 2 ml.

The product can be a cosmetic product and in particular a perfume. By using a highly concentrated perfume, the device can last for several months despite the small quantity contained in the reservoir, by limiting the quantity of atomised spray.

The invention also discloses a unit for atomising a product including:
a device as just described;
a recess configured to accommodate the device;
power supply means.

The power supply means can include a cell or a storage battery.

The unit can include a switch. It can additionally include a display to display product-related information, in particular the product type, the volume of product remaining, the product expiry date, an anti-counterfeit code, etc.

The unit can include several recesses each designed to accommodate a device such as that described previously. The unit can in particular include at least two devices containing a different product.

The unit can include attachment means to attach it to a garment.

Apart from the arrangements described above, the invention includes a certain number of other features which will be explained below, in relation to non-limitative embodiments, described in reference to the attached figures wherein:

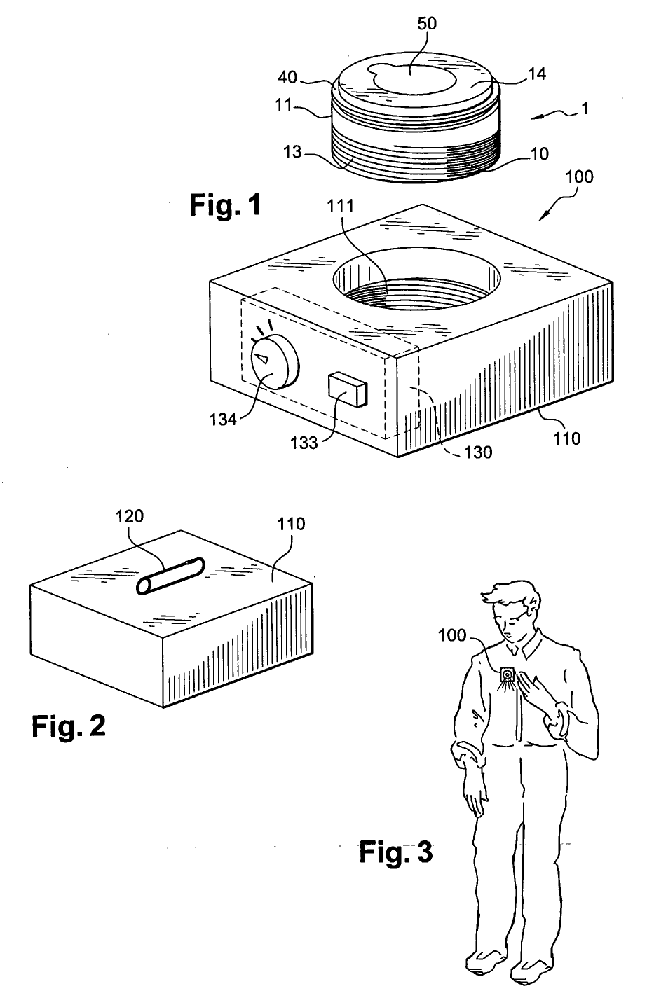

FIG. 1 illustrates a perspective view of a first embodiment of an atomiser unit according to the invention;

FIG. 2 shows a bottom view of the unit illustrated in FIG. 1;

FIG. 3 illustrates the atomiser unit depicted in FIG. 1 during use;

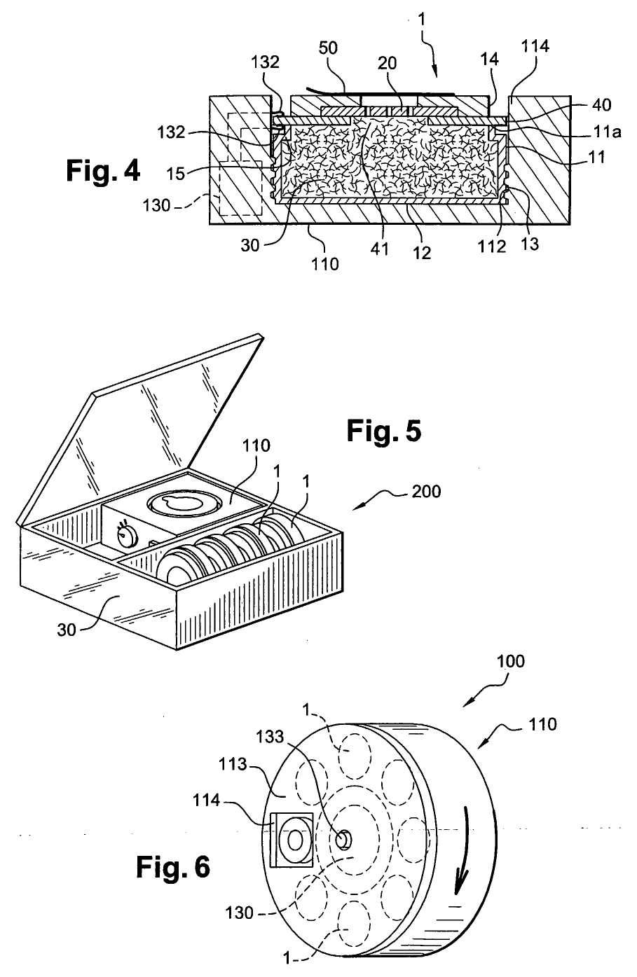

FIG. 4 is a sectional view of the unit depicted in FIG. 1;

FIG. 5 illustrates a kit including the atomiser unit depicted in FIG. 1 and several devices such as that shown in FIG. 3; and

FIG. 6 illustrates a second embodiment of the atomiser unit according to the invention.

The atomiser unit 100 illustrated in FIGS. 1 to 4 includes a housing 110 designed to receive in a removable manner a device 1 for atomising a product containing the product to be atomised, in particular a liquid product. In particular, the product to be atomised is a perfume, i.e. a composition including a mixture of odoriferous materials in a physiologically acceptable medium based on ethanol and possibly water.

The atomising device 1 includes a product reservoir 10 and a system to enable the product to be atomised when it is subjected to an electrical voltage generated by electrical means 130 provided in the housing 110.

The product reservoir 10 includes a sidewall 11, cylindrical in shape, and a bottom 12. The sidewall includes an indentation 15 in its upper part, the function of which will be explained below. The reservoir can of course have any other shape. The upper edge 11a of the sidewall 11 delineates a circular opening in which the atomising system is mounted.

As can be seen in particular in FIG. 4, the atomising system includes a piezoelectric element 40 in the form of a disc having a central opening 41. The piezoelectric element 40 is attached to the upper edge 11a of the sidewall 11 of the reservoir. It is for example glued, in proximity to its periphery, on the upper edge 11a of the sidewall 11.

The piezoelectric element 40 is composed of a ceramic plate, for example a sheet of zirconate. Alternatively, the plate can be made of another material, for example metaniobate or barium titanate. Such materials have the property of expanding or contracting when an electrical voltage is applied thereto. In addition, by virtue of its flat shape and its attachment in proximity to its periphery, the piezoelectric element 40 is able to vibrate and in particular to bend slightly when subjected to an electrical voltage.

In a particular example, the plate has a thickness of 1 mm, an outside diameter of 10 mm, and the diameter of the central opening 41 is 5 mm. The ceramic plate is metallised on each of its faces to facilitate the passage of an electrical current. It is for example coated in a very thin layer of silver, the silver layer being sufficiently thin so as not to prevent the piezoelectric plate from bending when it is subjected to an electrical field.

Depending on the nature of the product contained in the reservoir, the piezoelectric plate can be advantageously coated with a varnish to protect it from any chemical attack. Of course, it is possible to coat only that part of the plate which is in contact with the product.

A product-permeable wall 20 through which the product can be atomised is attached mechanically to the piezoelectric element 40. The wall 20 is for example glued around the central opening 41. It could alternatively be welded around the opening.

In the example shown, the wall 20 is a perforated membrane, the perforations being disposed opposite the central opening 41 in the piezoelectric element. The perforated membrane 20 is for example a nickel membrane with an outside diameter of approximately 7 mm. Other materials can be used, in particular metal alloys such as alloys of magnesium and zirconium, of composite materials, plastic materials, or combinations of these different materials. The membrane has a thickness between 10 and 100 μm, preferably around 30 μm. The perforations are composed of holes of very small size, with a diameter in the order of 25 μm. The membrane includes 100 holes for example. In particular, the membrane includes a sufficient number of holes so that the product is able to form a spray. The size of the perforations is chosen so that the droplets of the spray produced are sufficiently large so as not to be inhaled but not so large as to form a spray that is unduly wetting. A spray is produced for example that is composed of droplets approximately 30 μm in diameter.

Instead of using a perforated membrane, a mesh can be used as a variant.

A frame 14 partially covers the circumference of the perforated membrane 20 thereby protecting it. The frame 14 thus prevents the user from touching the perforated membrane with the fingers as it is set back slightly relative to the frame.

The product reservoir 10 thus forms a chamber closed by the sidewall 11 and the bottom 12, on the one hand, and by the ceramic plate 40 and the perforated membrane 20 on the other hand. By virtue of the surface tension, the liquid cannot flow out freely through the perforated membrane. Furthermore, the liquid to be atomised is only in contact with the ambient air through the membrane perforated with very small holes so that there is very little evaporation. Consequently, the product is perfectly preserved inside the reservoir.

A closure element 50 can nevertheless be provided to avoid any risk of evaporation of the product, in particular when it contains volatile compounds. The closure element 50 is a cover strip which is for example glued onto the frame 14. Any other type of closure element can of course be used, in particular a cap fitted with a sealing ring on its transverse wall which is designed to bear in a leaktight manner against the frame 14.

The perfume to be atomised is contained inside the product reservoir 11, and in particular within the pores of a porous member 30 disposed inside the reservoir.

The porous member 30 is for example composed of polyurethane fibres approximately 30 μm in diameter. The material for the fibres is chosen so as to retain all of its characteristics when in contact with the liquid to be atomised, in particular fibres are chosen that do not absorb the liquid.

A compressible porous member is preferably chosen which, in the expanded state, presents a volume slightly larger than the internal volume of the reservoir. The porous member is thus substantially compressed inside the reservoir so that it occupies substantially the whole of the internal volume of the reservoir. In this manner, the whole of the product to be atomised is contained inside the porous member so that liquid product cannot move freely inside the reservoir. The product cannot flow out of the reservoir through the perforated membrane. The device thus functions in all positions without risk of leakage if the device is placed with the perforated membrane facing downward.

Furthermore, the porous member 30 is in contact with the membrane so as to feed product thereto by capillary action. The porous member thus serves both to retain the liquid and also to deliver it to the membrane. The system is therefore simple to make as there is no need for an additional resilient system to ensure that the porous member comes into contact with the membrane in order to compensate for manufacturing tolerances.

In a particular example, the reservoir delineates a volume between 0.5 and 4 cm³, and in particular 1 cm³, and it contains 0.1 g of polyurethane fibres with a diameter of 30 μm. Before first use, the reservoir contains for example between 1 and 5 ml of product to be atomised, preferably between 1 and 2 ml, which corresponds to a usage time of approximately 3 months at the rate of one spray per day.

The device 1 containing the product is designed to be secured in a recess 111 in the housing to facilitate connection to the electrical means 130, in particular in a recess emerging via an opening 114. The electrical means 130 provided in the housing are arranged so as to generate an electrical field in the piezoelectric element thereby enabling the product to be atomised.

The electrical means 130 include an electrical source in the form of one or more power cells, in particular a dry cell rated at 1.5 V, 4.5 V or 9 V. The cell supplies two electrodes 132 which emerge into the recess 111 in the housing so that they can each be connected to the piezoelectric plate. The electrodes 132 take the form for example of flexible metal tabs, each of which comes into contact with one metallised face of the piezoelectric plate, the lower electrode being inserted into the recess formed by the indentation 15 provided in the wall 11 of the reservoir, under the piezoelectric plate.

A transformer is provided for example so that a voltage of approximately 20 V is measured across terminals of the electrodes 132, at 125 kHz.

Of course, the invention is not limited to a particular power source and other types of cells can be used such as lithium cells or electric storage batteries, for example a rechargeable battery, regardless of its technology (NiMh, Lilon, LiPo, etc).

The power source 130 generates a control signal enabling the piezoelectric plate to be suitably excited in both amplitude and frequency thereby causing it to vibrate by bending. In addition, the capacity of the cell is chosen so as to dispense the entire volume of perfume contained in the porous member.

An electrical switch 133 enables the user to cause electrical current to pass, and therefore to atomise the product as and when required.

The electrical means 130 can also include a regulating element 134 for example to enable the voltage at the terminals of the electrodes 132 to be adjusted. Given that the deformation of the piezoelectric element is proportional to the voltage applied, it will thus be possible to vary the spray of atomised product.

A programmed system, of the microcontroller type, can also control the spray emission time and intensity, and can react to external factors such as the near presence of a person.

The housing can additionally include a display to display product-related information, in particular the product type, the volume of product remaining, the product expiry date, an anti-counterfeit code, etc. In this case, provision is made in the device 1 for an electronic memory wherein the information is stored, the information being transmitted to the display device via the electrodes provided for the power supply.

To secure the device 1 in the housing 110, the device 1 includes fixing means designed to cooperate with counterpart fixing means provided inside the recess 111. In the example illustrated, the device 1 includes a screw thread 13 on its sidewall which engages with a counterpart screw thread 112 provided in the bottom of the recess. As a variant, provision can be made for the device to include a snap-on bead configured to engage in a groove provided in the wall of the housing defining the recess. The device can also be secured in the recess by a bayonet system.

The device 1 being detachably mounted in the housing, it can be readily changed in order to place another device in the housing. Provision can be made for example for the user to have a kit 200 which includes a single housing 110 such as just described and several devices 1 each containing a different perfume so as to obtain a box of different fragrances. The user can therefore use one perfume in preference to another according to his/her mood. The change of perfume is very quick and no contamination is possible. Indeed, no trace of the old perfume remains because the product reservoir as well as the permeable wall through which the product is atomised are both removed at the same time.

When the perfume is changed, the removed device 1 can be resealed with the cover strip 50 or a suitable cover. The perfume is thus protected from exposure to the air.

By virtue of its small size, the unit just described can be attached to a garment, in the manner of a broach, so as to be within hand's reach. The user can thus readily spray perfume whenever he/she wishes, as illustrated in FIG. 3.

To this end, the housing 110 includes, on its outer surface, attachment means 120 to attach the unit to a garment. In the example shown, the attachment means are in the form of a pin 120 illustrated in FIG. 2, the pin being for example welded on the outer surface of the housing, opposite the opening 114 in the recess 111. Alternatively, attachment means in the form of loops of the Velcro® type could be used.

As a variant, the unit can include means for attachment directly to the body. It can for example include a ring enabling it to be attached to a wrist in the manner of a bracelet.

In the example just described, the device 10 containing the perfume is independent of the electrical means 130 in that it is removable from the housing 110. As a variant, the device 1 can be equipped with a dedicated electrical circuit. It can for example be permanently mounted in a housing fitted with electrical means. In this case, a cell will preferably be chosen that has a capacity just sufficient to dispense the volume of perfume contained in the reservoir.

FIG. 6 illustrates another example of a unit 100 including a housing 110 in the form of a wheel in which several devices 1 are seated.

The different devices contain a different perfume for example. The devices 1 including the product can be identical to that described previously.

The devices 1 are preferably disposed around the periphery of the housing, in an annular part, whereas the electrical means 130 are provided in the central part of the housing. The electrical means 130 include two electrodes designed to successively energise each device 1. The electrical means 130 are integral with a frontal wall 113 of the housing which includes a window 114 against which a single device 1 is designed to be positioned at any one time. The electrodes are additionally arranged so that they come into contact with the piezoelectric element of the device 1 aligned with the window.

The annular part of the housing carrying the devices 1 is rotatably mobile relative to the rest of the housing so as to successively position one of the devices, and in particular, the product-permeable wall 20, against the window 114.

A switch is additionally provided to enable the user to cause electrical current to pass, thereby spraying the product through the window 114 when the device containing the perfume that he/she wishes to spray has been placed in alignment with the window.

Given that the atomising system is specific to each of the devices, the different perfumes are not mixed.

As a variant, the housing can be configured to enable several perfumes from several devices to be dispensed at the same time.

Here again such a housing can be designed to be worn on a garment, such as that described previously. Instead of being portable, this unit can be designed, as a variant, to be placed for example in a store to enable customers to test one of the perfumes offered in the different devices. It can then include a base to carry the housing.

In all of the examples just described, the devices 1 can be single-use. Alternatively, provision can be made to refill them with product when they are empty. To this end, an aperture can be provided in the wall of the reservoir, for example in the bottom 12, through which product can be injected, for example by means of a needle. The aperture can be closed by a plug, made of rubber for example. The device can also be refilled with a mixture of several fragrances so as to obtain a personalised fragrance.

The atomiser unit just described can also be used to atomise other cosmetic products, medicines or insecticides. It is possible in particular to atomise a medicine in its liquid form, for example for the treatment of asthma. In this case the device is used as a single-use atomiser system which then provides a totally hygienic solution.

In the foregoing detailed description reference is made to preferred embodiments of the invention. It is evident that variants thereto can be proposed without departing from the invention as claimed herebelow.

1. Device (1) for atomising a product including:
a reservoir (10) containing the product,
means of atomising the product which include:
a wall (20) permeable to the product through which the product is sprayed,
an actuator (40) designed to cause the permeable wall (20) to vibrate thereby atomising the product,
the device being characterised in that the reservoir contains a porous member (30), in contact with the permeable wall so as to feed product thereto, the porous member occupying substantially the entire volume of the reservoir.

2. Device according to claim 1, characterised in that the actuator includes a piezoelectric element.

3. Device according to any one of claims 1 or 2, characterised in that the porous member (30) is compressible.

4. Device according to claim 3, characterised in that the porous member (30) is at least partially compressed inside the reservoir.

5. Device according to any one of the foregoing claims, characterised in that the porous member (30) is a foam in a material selected from polyurethane or polyamide.

6. Device according to any one of claims 1 to 4, characterised in that the porous member (30) includes fibres in a material selected from polyurethane, polyamide, PET, or polyethylene.

7. Device according to any one of the foregoing claims, characterised in that the permeable wall (20) is a perforated membrane.

8. Device according to any one of claims 1 to 6, characterised in that the permeable wall (20) is a mesh.

9. Device according to any one of the foregoing claims, characterised in that the permeable wall (20) is fixed on the actuator (40).

10. Device according to any one of the foregoing claims, characterised in that the actuator (40) is in the form of an annular disc having a central opening (41), the product-permeable wall (20) being disposed in the central opening of the disc (40).

11. Device according to any one of the foregoing claims, characterised in that the reservoir (10) includes a sidewall (11) and a bottom (12), the actuator (40) being fixed on the edge of the sidewall, opposite the bottom.

12. Device according to any one of claims 2 to 11, characterised in that the piezoelectric element (40) includes a plate in a material selected from ceramics, barium titanate, or zinc oxide.

13. Device according to any one of the foregoing claims, characterised in that the product-permeable wall (20) is covered by a closure element (50) enabling the reservoir to be closed in a leaktight manner relative to the product.

14. Device according to the foregoing claim, characterised in that the closure element is a cover strip (50).

15. Device according to any one of the foregoing claims, characterised in that it includes fixing means (13) enabling it to be mounted in a unit (100) incorporating power supply means (130).

16. Device according to any one of the foregoing claims, characterised in that it includes an electronic memory wherein product-related information is stored.

17. Device according to any one of the foregoing claims, characterised in that the reservoir (10) delineates a volume between 2 and 4 cm³.

18. Device according to any one of the foregoing claims, characterised in that it includes, before first use, between 1 and 5 ml of product to be atomised, preferably between 1 and 2 ml.

19. Device according to any one of the foregoing claims, characterised in that the product is a cosmetic product.

20. Device according to the foregoing claim, characterised in that the product is a perfume.

21. Unit (100) for atomising a product including:
a device (1) according to any one of the foregoing claims;
a recess (111) configured to accommodate the device;
power supply means (130).

22. Unit according to the foregoing claim, characterised in that the power supply means include a power cell or a storage battery.

23. Unit according to any one of claims 21 to 22, characterised in that it includes a switch (133).

24. Unit according to any one of claims 21 to 23, characterised in that it includes a memory and a display to display product-related information, in particular the product type, the volume of product remaining, and the product expiry date.

25. Unit according to any one of claims 21 to 24, characterised in that it includes several recesses (111) each designed to accommodate a device (1) according to any one of claims 1 to 20.

26. Unit according to the foregoing claim, characterised in that it includes at least two devices (1) containing a different product.

27. Unit according to any one of claims 21 to 26, characterised in that it includes attachment means (120) to attach the unit to a garment.
